(19) United States
(12) Patent Application Publication
(10) Pub. No.: US 2023/0077631 A1
(43) Pub. Date: Mar. 16, 2023

(54) TIME DOMAIN MONITORING AND ADJUSTMENT BY A NETWORK INTERFACE DEVICE

(71) Applicant: Intel Corporation, Santa Clara, CA (US)

(72) Inventors: Daniel Christian BIEDERMAN, Saratoga, CA (US); Mark BORDOGNA, Andover, MA (US)

(21) Appl. No.: 17/992,747

(22) Filed: Nov. 22, 2022

(51) Int. Cl. H04L 43/087; H04L 41/5009; G06F 1/12

(52) U.S. Cl. CPC H04L 43/087; H04L 41/5009; G06F 1/12

(57) ABSTRACT

Examples described herein relate to a network interface device that includes a host interface; a network interface; and circuitry to: receive time information of a device that executes a service and based on the time information being outside of a permitted jitter range for the service, perform one or more actions to cause execution of the service on a device that operates based on a clock signal within a permitted jitter range.

### BACKGROUND

In distributed computing systems, operations are performed according to different clock signals and different time domains. Time stamp synchronization is used to attempt to synchronize time stamps in different time domains. However, where different devices utilize clock signals that are not synchronized with a reference clock signal, uncertainty in clock frequency and clock signal transitions can arise. Clock uncertainty can impact performance of applications in distributed computing systems and increase time to workload completion. For example, due to clock uncertainty, a distributed database may wait longer for retries of accesses to an entry.

### BRIEF DESCRIPTION OF THE DRAWINGS

FIG. 1 shows an example system.

FIG. 2 shows an example system.

FIG. 3 depicts an example of comparisons of rising edges of output signals against rising edges of a reference clock signal.

FIG. 4 depicts an example of determination of clock signal alignment based on 1 pulse per second (PPS).

FIG. 5 shows an example of time synchronization.

FIG. 6 shows an example of clock signal selection.

FIG. 7 depicts an example warehouse computer system.

FIG. 8 depicts an example process.

FIG. 9 depicts an example system.

FIG. 10 depicts an example system.

### DETAILED DESCRIPTION

At least to attempt to determine variation between one or more clock signals and a reference clock signal, one or more device or servers can communicate one or more clock signals via a low latency bus or connection to a network interface device. The network interface device can identify edges of the received one or more clock signals and based on comparisons with the reference clock signal, the network interface device can determine whether the received one or more clock signals are within a tolerance range of difference from clock edges of the reference clock signal. Based on whether a clock signal is identified as outside of the tolerance range, the network interface device can perform one or more of: migrate a service (e.g., one or more of: a virtual machine, container, microservice, serverless application, process, packet flow, queue, and so forth) to a different device or server that utilizes a clock signal that is within the tolerance range, deactivate or remove the device or server as a candidate to perform the service and another service, adjust the clock signal to be within the tolerance range, and/or other actions.

A network interface device can perform time signal synchronization of servers and monitor variances of time signals used by servers from a reference clock signal to attempt to cause distributed applications and services to utilize synchronized time signals. Performance of distributed applications and services (e.g., databases, artificial intelligence/machine learning (AI/ML)) can be improved based on monitoring and adjustments of timing signals in telecom or industrial scenarios such as a central office, factory, edge cabinet, including data centers, warehouse computing and other large data center. Devices and servers can be removed from use based on failure to meet time signal tolerance ranges or devices and servers can be added for use to provide time signals within time signal tolerance ranges.

In some examples, such as in a warehouse computer or one or more data centers, the reference clock signal can be synchronized with a main clock signal using Institute of Electrical and Electronics Engineers (IEEE) 1588 Precision Time Protocol (PTP), IEEE1588-2019, or protocols based thereon (e.g., J. Serrano, “The White Rabbit Project,” Proceedings of the ICALEPCS2009 (2009)).

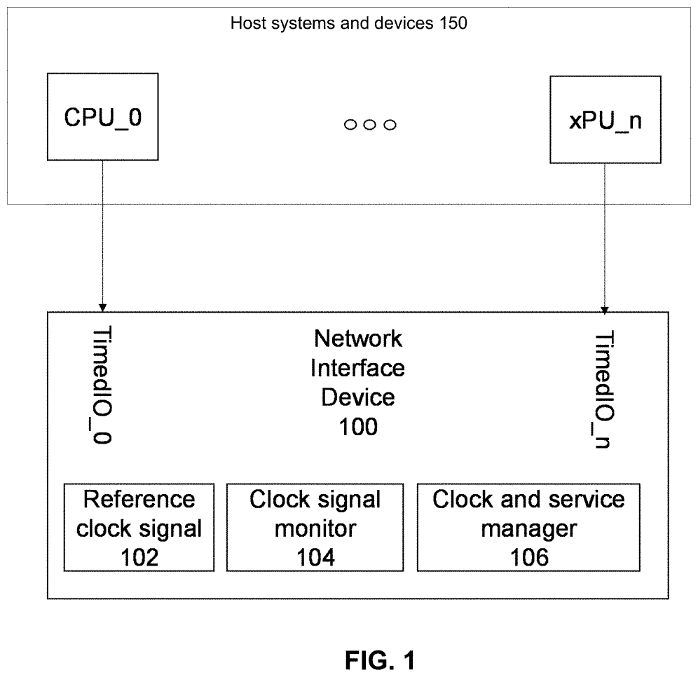

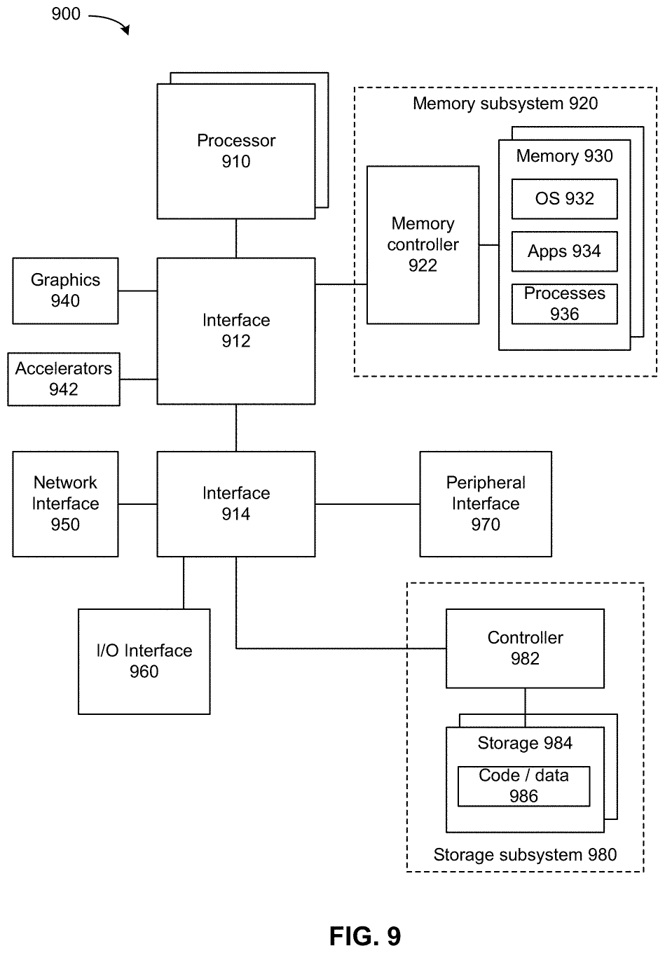

FIG. 1 shows an example system. In some examples, host systems and devices 150 can include various devices (e.g., central processing units (CPUs), xPUs, graphics processing units (GPUs), accelerators, memory devices, storage devices, memory controllers, storage controllers, network interface devices, and so forth). In some examples, host systems and devices 150 can include components described with respect to FIGS. 9 and/or 10. Host systems and devices 150 can be communicatively connected to network interface device 100 using a host or device interface (e.g., Peripheral Component Interconnect express (PCIe), Universal Chiplet Interconnect Express (UCIe), Compute Express Link (CXL), or others). In some examples, host systems and devices 150 can be communicatively connected to network interface device 100 as part of a system on chip (SoC) or integrated circuit.

Host systems and devices 150 can execute one or more services as well as other software described at least with respect to FIGS. 9 and/or 10. Various examples of a service include one or more of: a distributed database, distributed application, distributed AI/ML program, an application that is fully executed on one or more accelerators, an application that is partially executed on one or more accelerators, an application executed within a rack, at least part of the application is executed on a different rack, at least part of the application is in a different spine, at least part of the application is in a different data center, at least part of the application is in a different country, or at least part of the application is in a different continent.

In some examples, network interface device 100 can be implemented as one or more of: an infrastructure processing unit (IPU), data processing unit (DPU), smartNIC, forwarding element, router, switch, network interface controller, network-attached appliance (e.g., storage, memory, accelerator, processors, and/or security), and so forth. In some examples, the network interface device can provide time units to distributed computing environments and a data center.

In some examples, host systems and devices 150 can provide clock signals 0 to n as inputs TimedIO_0 to TimedIO_n, where n is an integer and n>1, to network interface device 100. Host systems and devices 150 can provide clock signals to network interface device 100 using wired or wireless communications. In some examples, a wired connection includes a conductive line, a trace, a bus, a coaxial cable, or others. Host systems and devices 150 can provide clock signals to network interface device 100 using a connection consistent with general-purpose input/output (GPIO), dedicated pin for transmitting pulses per second or a clock signal utilized by host systems and devices 150 to network interface device 100, or another communication interface.

In some examples, host systems and devices 150 can provide clock signals 0 to n based on a time stamp counter (TSC). For example, TSC can be based on a crystal clock source (e.g., Always Running Timer (ART)) can be utilized to provide time stamps from a device or server. For a description of the TSC within Intel® Architecture CPU cores, see volume 3, section 17.13.4 of Intel® 64 and IA-32 Architectures Software Developer's Manual (2019).

In some examples, network interface device 100 can utilize reference clock signal 102 as a reference clock signal to predict arrival time of rising or falling edges of another signal. An oscillator can provide reference clock signal 102 and can be on-die with network interface device 100 or off-die from network interface device 100. Based on reference clock signal 102 and clock signals 0 to n, corresponding to inputs TimedIO_0 to TimedIO_n, network interface device 100 can determine an amount of offset and determine whether the offset is within a range permitted for execution of a service on a system. For example, comparisons of rising edges of received clock signals can be made against rising edges of reference clock signal 102 to determine offsets among clock signals and reference clock signal 102. In some examples, reference clock signal 102 can refer to a reference counter and arrival times of a timing signal from host systems and devices 150 (e.g., pulse per second) can be compared against expected arrival counter times in the reference counter. Various examples of determining offsets are described herein.

Clock and service manager 106 can determine time differences between one or more rising edges of clock signals from a particular device or server from rising edges of reference clock signal 102. However, one or more falling edges can be compared against one or more falling edges of reference clock signal 102. A service or group of services can have a service level agreement (SLA) or service level objective (SLO) that specifies a permitted jitter range of differences between a clock signal utilized to execute the service or group of services.

For example, Table 1 depicts an example of time information data stored by clock and service manager 106. Table 2 depicts an example of permitted jitter specified by SLA or SLO for one or more processes.

TABLE 1

| | Time information | |
|---|---|---|
| Device or server | (jitter or offset) | |
| CPU0 | −100 | ns |
| Server1 | +0.25 | ns |
| GPU0 | +1 | ns |
| GPU1 | −12 | ns |
| Accelerator0 | +0.1 | μs |

TABLE 2

| Process | Permitted jitter or offset | |
|---|---|---|
| Service0 | +/−1 | ns |
| Service1 | +/−0.5 | μs |
| Service mesh0 | +/−0.05 | ms |

A service mesh can include an infrastructure layer for facilitating service-to-service communications between microservices using application programming interfaces (APIs). A service mesh can be implemented using a proxy instance (e.g., sidecar) to manage service-to-service communications. Some network protocols used by microservice communications include protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, nginx, and Open Service Mesh (OSM) are examples of control planes for a service mesh data plane.

To identify candidate chiplets, processors (e.g., CPUs, GPUs, accelerators, or other fixed or programmable circuitry), servers, or data centers with permitted time differences to execute a service, clock and service manager 106 can store differences between time information and the reference clock signal, such as using data shown in Table 2.

Based on the time differences being below or within the permitted jitter range for the service or group of services, clock and service manager 106 can permit the service to execute on a particular device or server. Based on the time differences being outside of the permitted jitter range for the service or group of services, clock and service manager 106 can perform one or more actions. For example, clock and service manager 106 can perform one or more of: migrate the service to execute on a different device or server that has a variation in clock signal within the permitted jitter range for the service, attempt to correct or reduce offset from reference clock signal 102, cause the device or server to be disabled for execution of a service, cause another device or server to be added to a network for use to execute the service, or others. Reference clock signal can be based on communications in accordance with IEEE1588, or other timing technologies.

For example, to attempt to correct or reduce offset of a clock signal of a device or server from reference clock signal 102, clock and service manager 106 can perform time domain translation based with interpolation variables (e.g., linear, quadratic, or beyond) between a clock signal and reference clock signal 102. For example, an adjustment to a clock signal based on PTM can be based on a linear relationship with a reference clock signal:

y=m*x+b, where

y represents a time stamp of a time domain of a device or server,

x represents a time stamp based on a reference clock signal 102 and/or PTP network-based time stamp,

m represents a linear coefficient, and

b represents an offset.

Clock and service manager 106 can determine based on several data points in some examples. The relationship can be non-linear such as quadratic or other curves. Clock and service manager 106 can re-determine the relationship periodically or in response to a command from an orchestrator or administrator.

In some examples, clock and service manager 106 can allocate hardware resources as part of a composed node or composite node to execute a service. For example, clock and service manager 106 can select one or more hardware resources to perform a service using workload orchestration in accordance with Kubernetes, Management and Orchestration (MANO), Docker, and so forth.

One or more TimedIO can communicate time information from a device and/or server to network interface device 100, where time information includes one or more of: a pulse per second, 10 KHz clock signal, or time information from multiple servers. In some examples, time information is based on the arrival time of a pulse at network interface device 100. In some examples, time information is based on departure time of a pulse from a server or device. In some examples, time information can represent one or more of: clock or timestamp information of: one or more processors (e.g., CPUs, GPUs, accelerators, or other fixed or programmable circuitry), one or more servers, or one or more chiplets (e.g., chiplets in a same package or different packages).

Clock signal monitor 104 can compare one or more time information to a reference clock signal to determine alignment or differences from the reference clock signal. In some examples, the reference clock signal includes one or more of: IEEE1588 grand clock, clock based on GPS, or other clock aligned with Coordinated Universal Time (UTC).

Based on differences between time information from a host server system and/or device and the reference clock signal being outside a permitted range difference, clock and service manager 106 can cause adjustments to the time signals generated or used at one or more of: a chiplet, processor, server, warehouse computer, data center, or multiple data centers in a same region or different continents. For example, clock and service manager 106 can cause adjustments to clock signals to reduce the differences at one or more chiplets, one or more processors, one or more servers, one or more warehouse computers, one or more data centers, or multiple data centers in a same region or different continents. For example, clock signals can be received at the network interface device and/or adjustment to clock signals can be made using PCIe precision time measurement (PTM), one or more timed GPIO pins, Ethernet, a bus, or other interconnect.

Based on differences between the time information and the reference clock signal being outside a permitted range tolerance, clock and service manager 106 can perform one or more of: disable a chiplet, processor, server, warehouse computer, or data center, not permit one or more services to execute on the chiplet, processor, server, warehouse computer, or data center, or migrate a service and its data to a different chiplet, processor, server, warehouse computer, or data center with time information that is within a permitted range. The permitted range can be based on an SLA or SLO for a service in a distributed database application or a distributed AI/ML application. For example, a distributed database may have +/−100 ns requirement and hence there is an SLA of +/−80 ns. Synchronization of time information of a system (e.g., servers, accelerators, etc.) and a reference clock signal could be set to be within a range of +/−50 ns. If timing information or clock source of a component inside the system strays outside the +/−50 ns tolerance, then it could be excluded from the processing of that distributed database, correction of timing information or clock source can occur, or data and processing would be migrated to a different server, accelerator, or device with time information or clock source meeting the permitted range.

Clock and service manager 106 can issue an alarm or error message and identify such device or entity to an orchestrator or administrator that of differences between a time information and the reference clock signal being outside a permitted range tolerance for one or more of: chiplet, processor, server, warehouse computer, or data center.

Accordingly, clock and service manager 106 can determine time information for multiple devices and servers in one or more data centers or warehouses based on comparison with a reference clock signal and select resources to perform processes to reduce clock uncertainty or likelihood permitted clock jitter is violated.

In some examples, multiple network interface devices in a rack or spine can manage clock signals relative to one or more reference clocks of one or more of: one or more chiplets, one or more processors, one or more servers, one or more devices in at least one warehouse computer, one or more data centers, or multiple data centers in a same region or different continents. Servers can be in different racks, different spines, different data centers, different countries, or different continents. In some examples, multiple network interface devices in a rack or spine can cause execution of one or more processes based on timing information relative to one or more reference clocks on one or more of: a chiplet, processor, server, one or more devices in at least one warehouse computer, data center, or multiple data centers in a same region or different continents. The one or more reference clocks can be based on IEEE 1588 Grandmaster clock, IEEE 1588 Precision Time Protocol (PTP), White Rabbit, or others.

In some examples, using a single control signal, one or more network interface devices can adjust clock signals of one or more of: a chiplet, processor, server, one or more devices in at least one warehouse computer, data center, or multiple data centers in a same region or different continents. The control signal from the network interface device can be shared among chiplets,

In some examples, instead of network interface devices determining time information and adjusting clock signals, one or more servers or server dies can determine time information and adjust clock signals.

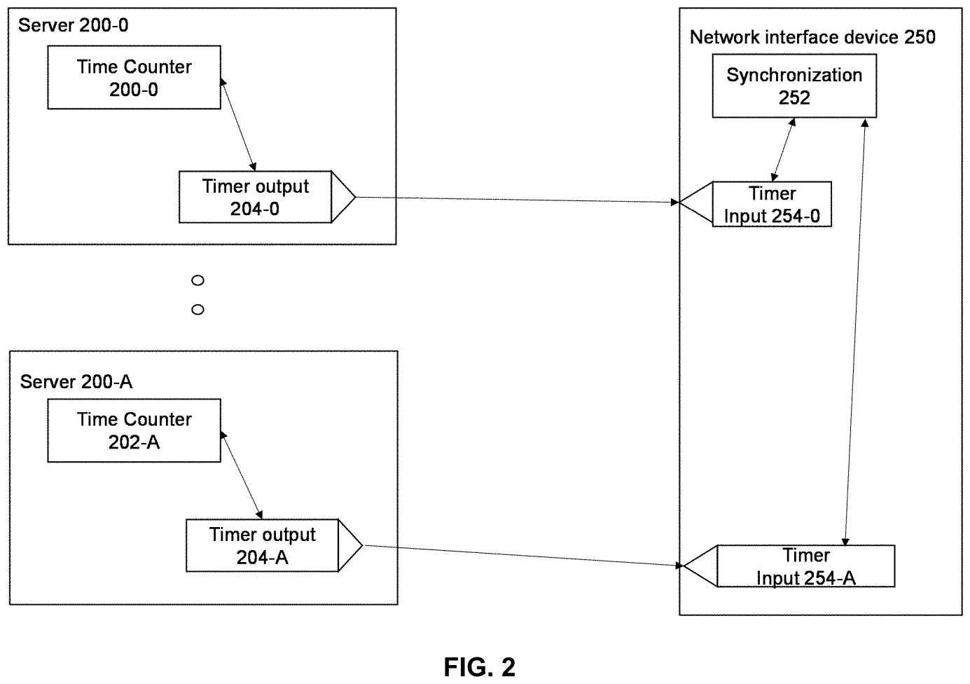

FIG. 2 shows an example system. In some examples, network interface device 250 can receive timing signals from servers 200-0 to 200-A, where A is an integer and A>1, and determine which of the timing signals are not within a configured permitted offset from a reference clock signal. For example, one or more of servers 200-0 to 200-A can issue respective timer output signals via timer output pins 204-0 to 204-A to network interface device 250. One or more pins can provide generates one or more pulses (e.g., one pulse per second, a clock signal, etc.) to network interface device 250. Network interface device 250 can determine an actual time or count that the pulse was received by network interface device 250 and the time count could be compared with a time or count of the counter/time expected for the pulse or edge by synchronization circuitry 252. Synchronization circuitry 252 can determine offsets of edges of output signals 204-0 to 204-A conveyed by respective timer inputs 254-0 to 254-A from edges of a reference clock signal.

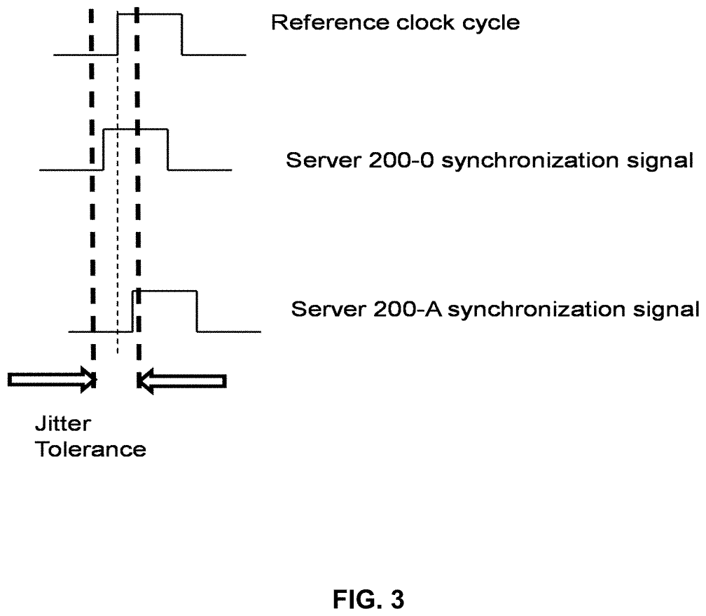

For example, FIG. 3 depicts an example of comparisons of rising edges of output signals 204-0 and 204-A against rising edges of the reference clock signal. In this example, server 200-0 clock is slower than reference clock as the rising edge of server 200-0 clock leads the rising edge of the reference clock signal whereas server 200-A clock is slower than reference clock as the rising edge of server 200-A clock lags the rising edge of the reference clock signal. Note that instead of clock signals, one or more of servers 200-0 to 200-A can provide synchronization pulses.

Note that although pulses are depicted, the reference clock signal could be a time on a timer or a count of a counter that indicated when a rising edge is expected to have occurred. Likewise, rising edges of 200-0 and 200-A could be the arrival time at a network interface device or monitoring device, based on a timer or counter, or reference used by that timer or counter, such as a main timer.

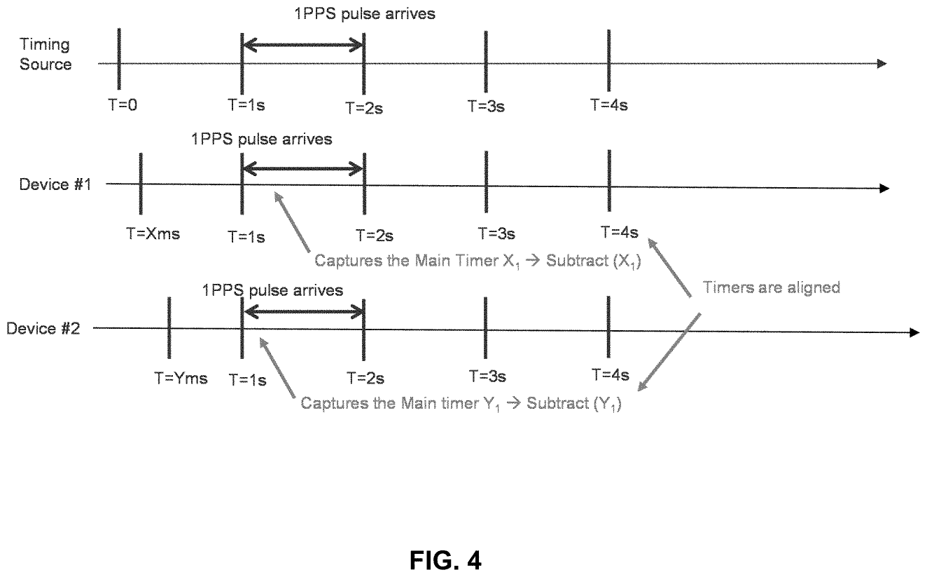

FIG. 4 depicts an example of determination of clock signal alignment based on 1 pulse per second (PPS). A reference clock signal can provide a timing source to determine occurrences of 1 second intervals (e.g., T=0, T=1 s, T=2 s, etc.) Device #1 and device #2 can represent devices or servers and can provide pulses at 1 second intervals via a low latency interface such as GPIO, or other interfaces, to a network interface device. Although examples are described with respect to 1 second intervals, other time intervals such as 500 milliseconds or based on a 10 kHZ clock. In this example, a network interface device can provide a constant value to offset (add or subtract) to a time based on a clock signal in order to align 1 PPS intervals with 1 PPS intervals of a reference clock signal timing source. Note that the constant value can be a b value in the PTM offset value described earlier. The constant value can be recalculated to determine offsets of 1 PPS intervals from Devices 1 and 2 relative to 1 PPS based on a reference clock signal timing source. 1 PPS alignment (or other numbers of pulses per second) can reduce frequency and/or phase errors.

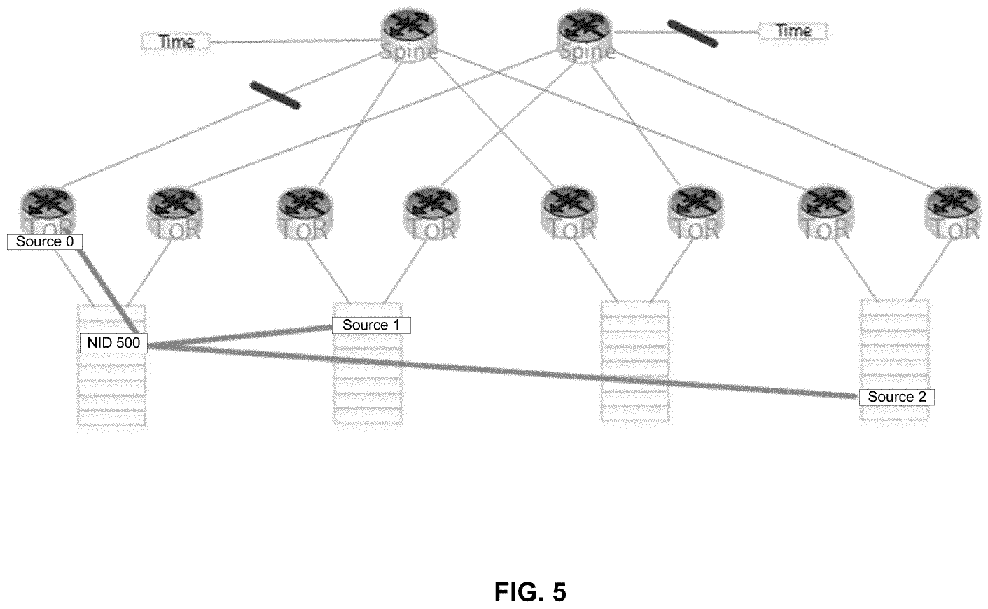

FIG. 5 depicts a network interface device in a server in a data center receiving time from three sources, namely top of rack (ToR) switch (Source 0), and other servers (Source 1 and Source 2) connected to other ToR switches. Were network interface device 500 to receive time information from merely a single device (e.g., ToR rack switch) or time grandmaster over the spine network, a reference clock signal utilized by network interface device 500 could drift relative to a main reference clock signal. However, network interface device 500 utilizing clock signals from one or more other servers or switches can allow network interface device 500 to compare and synchronize the reference clock signal to multiple reference clock signals. By referencing timing signals from multiple devices, a more accurate and or more precise time can be created and shared among the devices. For example, in a warehouse computer, network interface device 500 could monitor the clocks and timers of other network interface devices, switches, and servers to confirm that they are within compliance and possibly adjust to clocks and timers to attempt to maintain offsets of clocks and timers in the warehouse computer within a given tolerance. Note that while a network interface device in a server is shown, it could be implemented in any switch, xPU, appliance, or other piece of data center equipment.

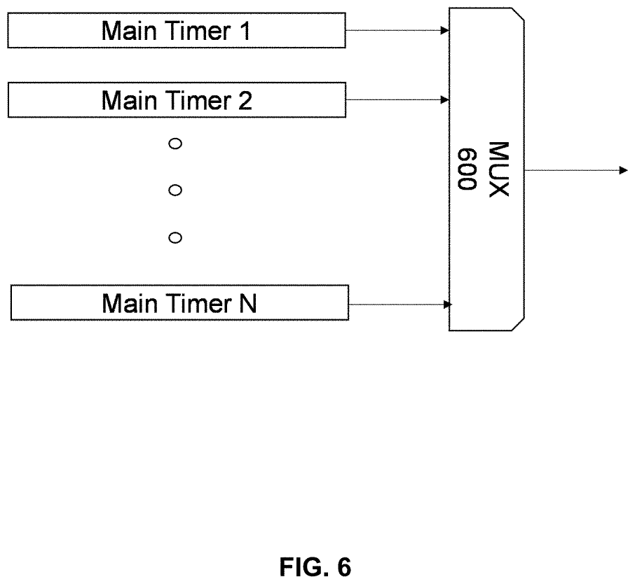

FIG. 6 shows a system can be used to select from among an integer N number of main timers. For example, multiplexer (MUX) 600 can receive N number of main timer signals and select from among the N main timer signals to output based on a main timer closest to a median or average of other devices or an algorithm to select which timer it is best to use.

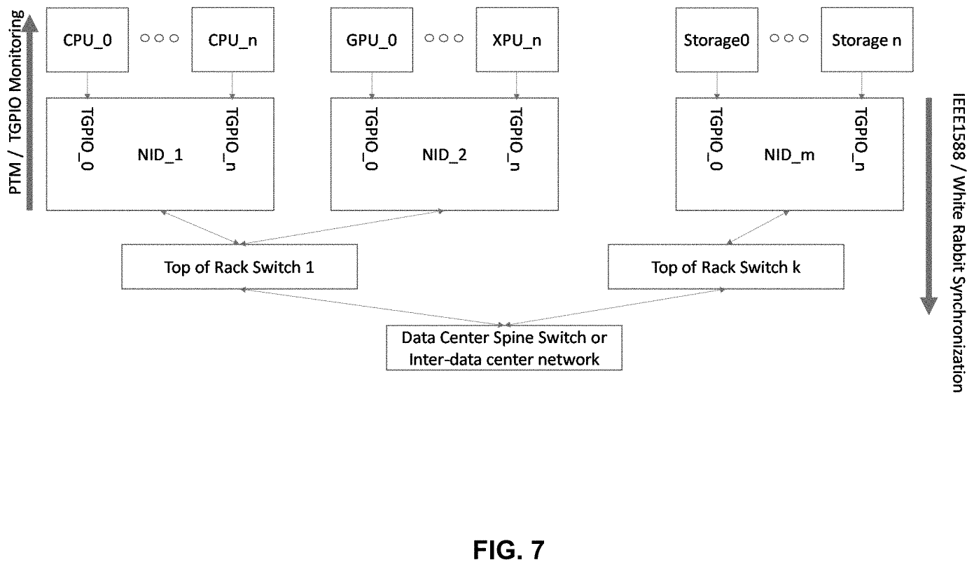

FIG. 7 depicts an example warehouse computer system. In some examples, a warehouse computer can include one or more CPUs, GPUs, XPUs, accelerators, storage nodes, memory nodes, and other devices. For example, accelerators can include AI/ML accelerators, storage accelerators and accelerators can communicate using Ethernet or Remote Direct Memory Access (RDMA) protocol. Network interface device_1 (NID_1) can monitor and adjust clock signals of CPU_0 to CPU_n using TGPIO Monitoring and/or PTM described herein based on a tolerance range configured by an administrator or orchestrator. One or more of NID_2 to NID_m, where m is an integer, can monitor and adjust clock signals of devices such as GPUs, XPUs, storage nodes and so forth using TGPIO Monitoring and/or PTM described herein based on a tolerance range configured by an administrator or orchestrator.

One or more of Top of rack (ToR) switch 1 to ToR switch k, where k is an integer, can monitor and adjust clock signals of NID_1 to NID_m based on IEEE1588, White Rabbit, or other technologies to keep precision of clock signals of NID_1 to NID_m within a tolerance range configured by an administrator or orchestrator.

Data center spline switch or inter-data center network can monitor and adjust clock signals of ToR switch 1 to ToR switch k based on IEEE1588, White Rabbit, or other technologies to keep precision of clock signals of ToR switch 1 to ToR switch k within a tolerance range configured by an administrator or orchestrator.

Accordingly, a geographically dispersed warehouse computing system can utilize one or more network interface devices to coordinate time among one other using monitoring using both TGPIO, IEEE1588, White Rabbit, or other wired or wireless technologies.

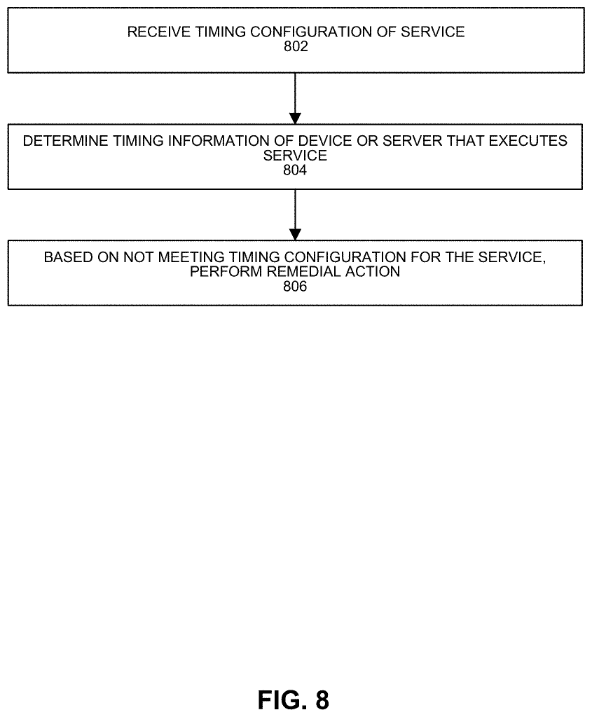

FIG. 8 depicts an example process. The process can be performed by a network interface device, host server, and/or service. At 802, a configuration of a permitted jitter range for a service can be specified. For example, an SLA or SLO of a service or group of services can specify a permitted time difference between edges of a clock signal used by a processor to execute the service and a reference clock signal. At 804, a determination of jitter between the clock signal used by the processor to execute the service and the reference clock signal can be determined. Jitter can be expressed in offset of edges in terms of time between the clock signal used by the processor to execute and the service and the reference clock signal. At 806, based on the clock signal used by the processor to execute the service and the reference clock signal being outside of the permitted jitter range, an action can be performed. For example, the action can include one or more of: migrate the service to execute on a different device or server that has a variation in clock signal within the permitted jitter range for the service, attempt to correct or reduce an offset of the clock signal from the reference clock signal, cause a device or server to be disabled for execution of the service, cause another device or server to be added to a network for use to execute the service, or others.

FIG. 9 depicts an example computing system. System 900 can be used to program network interface device 950 or other circuitry (e.g., processors 910 or a process executed thereon) to perform jitter evaluation of clock signals relative to a reference clock signal for one or more services and perform remedial actions, as described herein. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver (e.g., Linux® driver or OS driver such as Linux® ptp41) can configure and/or offload to network interface 950 to perform jitter evaluation of clock signals relative to a reference clock signal for one or more services and perform remedial actions, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include a physical layer interface (PHY), media access control (MAC) decoder and encoder circuitry, an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Some examples of network interface 950 are part of an Infrastructure Processing Unit (IPU) or data processing unit (DPU) or utilized by an IPU or DPU. An xPU can refer at least to an IPU, DPU, GPU, general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

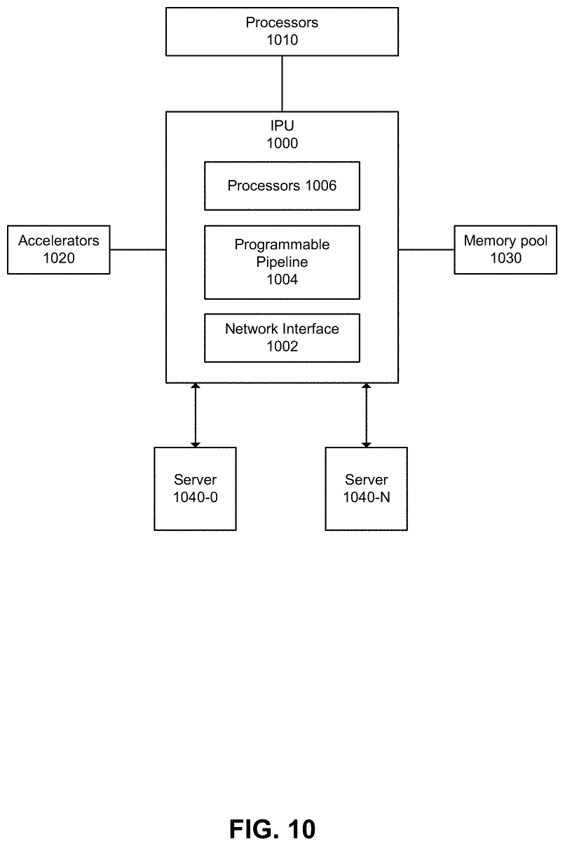

FIG. 10 depicts an example system. Devices and software of system 1000 can perform jitter evaluation of clock signals relative to a reference clock signal for one or more services and perform remedial actions, as described herein, as described herein. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002.

In some examples, devices and software of IPU 1000 can perform capabilities of a router, load balancer, firewall, TCP/reliable transport, service mesh, data-transformation, authentication, security infrastructure services, telemetry measurement, event logging, initiating and managing data flows, data placement, or job scheduling of resources on an XPU, storage, memory, or central processing unit (CPU).

In some examples, devices and software of IPU 1000 can perform operations that include data parallelization tasks, platform and device management, distributed inter-node and intra-node telemetry, tracing, logging and monitoring, quality of service (QoS) enforcement, service mesh, data processing including serialization and deserialization, transformation including size and format conversion, range validation, access policy enforcement, or distributed inter-node and intra-node security.

Programmable pipeline 1004 can include one or more packet processing pipeline that can be configured to perform match-action on received packets to identify packet processing rules and next hops using information stored in a ternary content-addressable memory (TCAM) tables or exact match tables in some embodiments. Programmable pipeline 1004 can include one or more circuitries that perform match-action operations in a pipelined or serial manner that are configured based on a programmable pipeline language instruction set. Processors, FPGAs, other specialized processors, controllers, devices, and/or circuits can be used utilized for packet processing or packet modification. For example, match-action tables or circuitry can be used whereby a hash of a portion of a packet is used as an index to find an entry. Programmable pipeline 1004 can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of programmable pipeline 1004, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

Programmable pipeline 1004 and/or processors 1006 can perform jitter evaluation of clock signals relative to a reference clock signal for one or more services and perform remedial actions, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network interface device comprising a host interface; a network interface; and circuitry to: receive time information of a device that executes a service and based on the time information being outside of a permitted jitter range for the service, perform one or more actions to cause execution of the service on a device that operates based on a clock signal within a permitted jitter range.

Example 2 includes one or more examples, wherein the service is part of a group of distributed services executing on one or more of: a chiplet, processor, server, warehouse computer, data center, or multiple data centers.

Example 3 includes one or more examples, wherein the one or more actions comprise one or more of: migrate the service to execute on a different device or server with a variation in clock signal within the permitted jitter range for the device, reduce offset of the clock signal from a reference clock signal, cause the device to be disabled to execute the service, or request another device or server to be added for use to execute the service.

Example 4 includes one or more examples, wherein the reference clock signal is synchronized with a main timer based on one or more of: Institute of Electrical and Electronics Engineers (IEEE) 1588 Precision Time Protocol (PTP), IEEE1588-2019, or White Rabbit Project.

Example 5 includes one or more examples, wherein the time information is received from a connection consistent with general-purpose input/output (GPIO).

Example 6 includes one or more examples, wherein the permitted jitter range for the service is based on a service level agreement (SLA) for the service.

Example 7 includes one or more examples, wherein the clock signal comprises a 1 pulse per second (PPS) indicator signal.

Example 8 includes one or more examples, wherein the network interface device comprises one or more of: an infrastructure processing unit (IPU), data processing unit (DPU), smartNIC, forwarding element, switch, router, network interface controller, or network-attached appliance.

Example 9 includes one or more examples, and includes a server communicatively coupled to the network interface device, wherein the server is to execute the service and utilize the clock signal to time operations of the service.

Example 10 includes one or more examples, and includes a data center, wherein the data center comprises the server and a second server and wherein the perform one or more actions to cause execution of the service on a device that operates based on a clock signal within a permitted jitter range comprises select the second server to execute the service based on a second time information for the second server being inside of the permitted jitter range for the service.

Example 11 includes one or more examples, and includes a non-transitory computer-readable medium comprising instructions stored thereon, that if executed by one or more processors, cause the one or more processors to: execute a driver to configure a network interface device to perform: determine a difference between a clock signal of a device and a reference clock signal and based on the difference being outside of a permitted jitter range for a service, perform one or more actions to cause execution of the service on a device that operates based on a clock signal within a permitted jitter range.

Example 12 includes one or more examples, wherein the service is part of a group of distributed services executing on one or more of: a chiplet, processor, server, warehouse computer, data center, or multiple data centers.

Example 13 includes one or more examples, wherein the one or more actions comprise one or more of: migrate the service to execute on a different device or server with a variation in clock signal within the permitted jitter range for the device, reduce offset of the clock signal from a reference clock signal, cause the device to be disabled to execute the service, or request another device or server to be added to execute the service.

Example 14 includes one or more examples, wherein the reference clock signal is synchronized with a main timer based on one or more of: IEEE 1588 Precision Time Protocol (PTP), IEEE1588-2019, or White Rabbit Project.

Example 15 includes one or more examples, wherein the permitted jitter range for the service is based on a service level agreement (SLA) for the service.

Example 16 includes one or more examples, and includes a method comprising: determining a difference between a time information of a device and edges of a reference clock signal and based on the difference being outside of a permitted jitter range for a service, performing one or more actions to cause execution of the service on a device that operates based on a clock signal within a permitted jitter range.

Example 17 includes one or more examples, wherein the service is part of a group of distributed services executing on one or more of: a chiplet, processor, server, warehouse computer, data center, or multiple data centers.

Example 18 includes one or more examples, wherein the one or more actions comprise one or more of: migrate the service to execute on a different device or server with a variation in clock signal within the permitted jitter range for the device, reduce offset of the clock signal from a reference clock signal, cause the device to be disabled to execute the service, or request another device or server to be added to execute the service.

Example 19 includes one or more examples, wherein the reference clock signal is synchronized with a main timer based on one or more of: IEEE 1588 Precision Time Protocol (PTP), IEEE1588-2019, or White Rabbit Project.

Example 20 includes one or more examples, wherein the time information is received from a connection consistent with general-purpose input/output (GPIO).

What is claimed is:

1. An apparatus comprising:
a network interface device comprising
a host interface;
a network interface; and
circuitry to:
receive time information of a device that executes a service and
based on the time information being outside of a permitted jitter range for the service, perform one or more actions to cause execution of the service on a device that operates based on a clock signal within a permitted jitter range.

2. The apparatus of claim 1, wherein the service is part of a group of distributed services executing on one or more of: a chiplet, processor, server, warehouse computer, data center, or multiple data centers.

3. The apparatus of claim 1, wherein the one or more actions comprise one or more of: migrate the service to execute on a different device or server with a variation in clock signal within the permitted jitter range for the device, reduce offset of the clock signal from a reference clock signal, cause the device to be disabled to execute the service, or request another device or server to be added for use to execute the service.

4. The apparatus of claim 3, wherein the reference clock signal is synchronized with a main timer based on one or more of: Institute of Electrical and Electronics Engineers (IEEE) 1588 Precision Time Protocol (PTP), IEEE1588-2019, or White Rabbit Project.

5. The apparatus of claim 1, wherein the time information is received from a connection consistent with general-purpose input/output (GPIO).

6. The apparatus of claim 1, wherein the permitted jitter range for the service is based on a service level agreement (SLA) for the service.

7. The apparatus of claim 1, wherein the clock signal comprises a 1 pulse per second (PPS) indicator signal.

8. The apparatus of claim 1, wherein the network interface device comprises one or more of: an infrastructure processing unit (IPU), data processing unit (DPU), smartNIC, forwarding element, switch, router, network interface controller, or network-attached appliance.

9. The apparatus of claim 1, comprising a server communicatively coupled to the network interface device, wherein the server is to execute the service and utilize the clock signal to time operations of the service.

10. The apparatus of claim 9, comprising a data center, wherein the data center comprises the server and a second server and wherein the perform one or more actions to cause execution of the service on a device that operates based on a clock signal within a permitted jitter range comprises select the second server to execute the service based on a second time information for the second server being inside of the permitted jitter range for the service.

11. A non-transitory computer-readable medium comprising instructions stored thereon, that if executed by one or more processors, cause the one or more processors to:
execute a driver to configure a network interface device to perform:
determine a difference between a clock signal of a device and a reference clock signal and
based on the difference being outside of a permitted jitter range for a service, perform one or more actions to cause execution of the service on a device that operates based on a clock signal within a permitted jitter range.

12. The computer-readable medium of claim 11, wherein the service is part of a group of distributed services executing on one or more of: a chiplet, processor, server, warehouse computer, data center, or multiple data centers.

13. The computer-readable medium of claim 11, wherein the one or more actions comprise one or more of: migrate the service to execute on a different device or server with a variation in clock signal within the permitted jitter range for the device, reduce offset of the clock signal from a reference clock signal, cause the device to be disabled to execute the service, or request another device or server to be added to execute the service.

14. The computer-readable medium of claim 11, wherein the reference clock signal is synchronized with a main timer based on one or more of: IEEE 1588 Precision Time Protocol (PTP), IEEE1588-2019, or White Rabbit Project.

15. The computer-readable medium of claim 11, wherein the permitted jitter range for the service is based on a service level agreement (SLA) for the service.

16. A method comprising:
determining a difference between a time information of a device and edges of a reference clock signal and
based on the difference being outside of a permitted jitter range for a service, performing one or more actions to cause execution of the service on a device that operates based on a clock signal within a permitted jitter range.

17. The method of claim 16, wherein the service is part of a group of distributed services executing on one or more of: a chiplet, processor, server, warehouse computer, data center, or multiple data centers.

18. The method of claim 16, wherein the one or more actions comprise one or more of: migrate the service to execute on a different device or server with a variation in clock signal within the permitted jitter range for the device, reduce offset of the clock signal from a reference clock signal, cause the device to be disabled to execute the service, or request another device or server to be added to execute the service.

19. The method of claim 16, wherein the reference clock signal is synchronized with a main timer based on one or more of: IEEE 1588 Precision Time Protocol (PTP), IEEE1588-2019, or White Rabbit Project.

20. The method of claim 16, wherein the time information is received from a connection consistent with general-purpose input/output (GPIO).
